(19) United States
(12) Patent Application Publication
(10) Pub. No.: US 2002/0162226 A1
(43) Pub. Date: Nov. 7, 2002

(54) Hair clipper with pivoting clipper head assembly

(75) Inventors: Paul Andrew Abraham, Mount Kisco, NY (US); John David Almstead JR., Ridgefield, CT (US); Richard Neil Tobin, Stamford, CT (US)

Correspondence Address: CHARLES N.J. RUGGIERO, ESQ., OHLANDT, GREELEY, RUGGIERO & PERLE, L.L.P., 10th Floor, ONE LANDMARK SQUARE, STAMFORD, CT, 06901-2682, US

(73) Assignee: CONAIR CIP, INC.

(21) Appl. No.: 10/085,722

(22) Filed: Feb. 28, 2002

Related U.S. Application Data
(63) Continuation-in-part of application No. 09/702,036, filed on Oct. 30, 2000.

(51) Int. Cl. B26B 19/02

(52) U.S. Cl. 30/210; 30/527

(57) ABSTRACT

A hair clipper having a pivoting clipper head is provided. The hair clipper has a clipper head, a handle and connectors for connecting the handle and the head. The clipper head has a cutting assembly located thereon. The handle has a longitudinal axis, a motor and a drive shaft driven by the motor. The connectors connect the clipper head and the handle such that the clipper head pivots about an axis of rotation that is perpendicular to the longitudinal axis of the handle.

### BACKGROUND OF THE INVENTION

1. Field of the Invention

The present invention relates to hair clippers. More particularly, the present invention relates to a hair clipper having a pivoting clipper head assembly.

2. Description of the Prior Art

Electric hair clippers having a stationary blade and a reciprocating blade are known in the art. The stationary blade and the reciprocating blade each have a plurality of teeth along the leading edge of the blades. The blades are mounted to the clipper such that the teeth of the stationary blade are substantially parallel to the teeth of the reciprocating blade. In this manner, reciprocating the reciprocating blade with respect to the stationary blade trims hair positioned between the teeth.

Electric nose and ear hair clippers are also well known in the art. Various types of these personal clippers have been developed over the years to improve the ease and effectiveness of trimming unwanted hairs growing within nasal and ear cavities. Most of these devices have focused on the cutting assembly. For example, U.S. Pat. No. 5,012,576 describes a device having a cutting head attached to a rotatable shaft with blades that are angled to provide a fan-like action when rotated. Other examples of personal clippers with unique cutting assemblies include U.S. Pat. Nos. 6,151,785, 4,958,432, 4,868,984, 3,965,569, 3,925,888, and U.S. Pat. No. 3,699,652.

Cutting assemblies for both conventional hair clippers and nose and ear hair clippers have been typically mounted to the end of an elongated, essentially tubular housing. Accordingly, a user must maneuver the clipper to various angles to optimally position the cutting assembly to effectively and efficiently cut the hard to reach hair surface areas of a user. Thus, it is desirable to provide a hair clipper that permits adjustment of the blade assembly with respect to the handle to better enable the user to position the blade assembly to more easily and effectively reach and maneuver the device with respect to the hard to reach hair surface areas of the user.

### SUMMARY OF THE INVENTION

It is an object of the present invention to provide a hair clipper having a pivoting clipper head.

It is another object of the present invention to provide a clipper having a clipper head assembly that is pivotable about an axis of rotation that is perpendicular to the handle.

It is a further object of the present invention to provide a hair clipper having up to five, discrete positions for the clipper head.

These and other objects and advantages of the present invention are achieved by the hair clipper of the present invention. The hair clipper includes a main body having a distended lower portion forming a handle and a distended upper portion, or clipper head, pivotally connected to said handle by one or more connectors. The handle has two laterally opposed arms forming a Y-shaped groove for receiving the pivoting clipper head. The arms are connected to the clipper head by one or more connectors. The clipper head has a cutting assembly that extends from one end. The cutting assembly can be any blade mechanism known for use with a conventional hair clipper or a nose and ear hair clipper.

### DESCRIPTION OF THE FIGURES

FIG. 1 is a first plan view of the clipper of a first embodiment of the present invention;

FIG. 2 is a second plan view, opposite the first plan view of the clipper of FIG. 1;

FIG. 3 is an exploded view of the clipper of FIG. 2;

FIG. 4 is a first plan view of a second embodiment of the clipper of the present invention showing a alternate cutting assembly;

FIG. 5 is a first side view of the clipper of FIGS. 1 and 4 showing the clipper head in its first position;

FIG. 6 is the first side view of the clipper of FIGS. 1 and 4 showing the clipper head in its second position;

FIG. 7 is the first side view of the clipper of FIGS. 1 and 4 showing the clipper head in its third position;

FIG. 8 is the first side view of the clipper of FIGS. 1 and 4 showing the clipper in its fourth position; and

FIG. 9 is the first side view of the clipper of FIGS. 1 and 4 showing the clipper head in its fifth position.

### DETAIL DESCRIPTION OF THE INVENTION

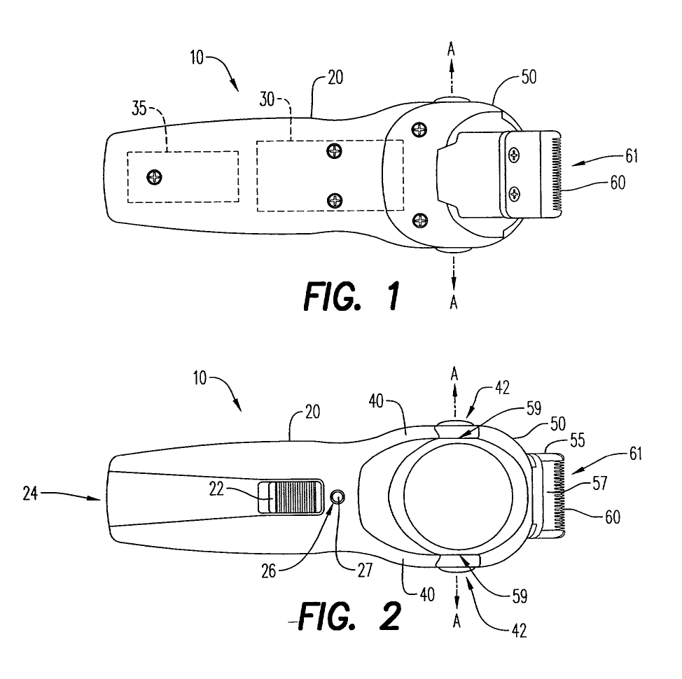

Referring to the figures and particularly to FIG. 1, a nose and ear clipper generally represented by reference numeral 10, is shown. Clipper 10 preferably has a handle portion 20 and a cutting head assembly 50.

In a first, preferred embodiment of clipper 10 shown in FIG. 1., the clipper is a rechargeable clipper. In this embodiment, handle 20 houses a motor 30 and a battery 35 shown in FIG. 2.

Referring to FIG. 2, handle 20 preferably has an on-off switch 22, a plug 24, and a recharging indicator 26. Switch 22 preferably has an on position, an off position, and a lock feature. Motor 30 is preferably operatively connected to battery 35 when switch 22 is in the on position. Battery 35 is preferably operatively connected to plug 24 and recharging indicator 26 when switch 22 is in the off position. In operation, when switch 22 is placed in the on position, power flows from battery 35 to motor 30. Further, when switch 22 is in the off position, battery 35 is operatively connected to plug 24 and recharging indicator 26 such that the plug 24 when connected to a standard household electrical outlet delivers power to recharge the battery and to operate recharging indicator 26. Still further, the locking feature of switch 22 is preferably used to lock the switch into either the on position or off position as desired. Indicator 26 has a first state when battery 35 is recharging and a second state when the battery is fully recharged.

In this embodiment shown in FIG. 2, indicator 26 is preferably a light emitting diode or LED 27. LED 27 has a first on or illuminated state and a second off state. In use, LED 27 is preferably illuminated when battery 35 is recharging and the LED is off when the battery is fully recharged.

In an alternative embodiment of clipper 10 (not shown), the clipper is not rechargeable. In this alternative embodiment, handle 20 preferably houses motor 30. Motor 30 is operatively connected to plug 24 when switch 22 is in the on position. In operation, switch 22 is placed in the on position to cause power to flow to motor 30 from a standard household electrical outlet connected to a power cord, not shown, which is connected to plug 24.

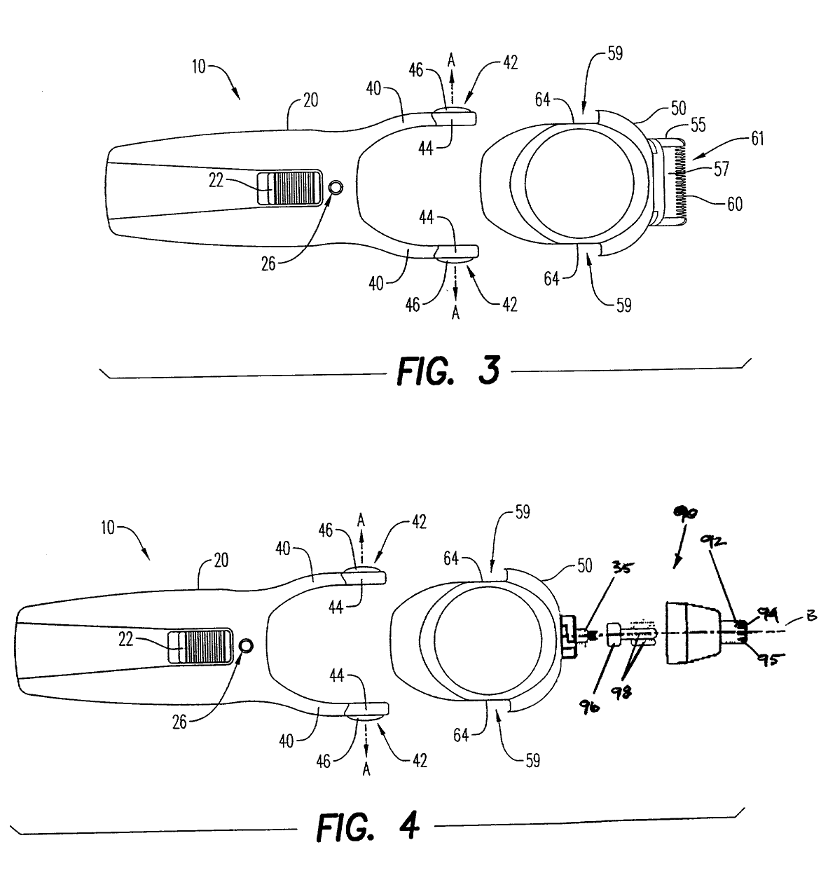

Referring to FIG. 3, clipper head 50, similar to prior art conventional hair clippers, includes stationary blade 55 and reciprocating blade 57. Blade 55 and blade 57 each have a plurality of teeth 60 along the leading edge of the blades. Blade 55 and blade 57 are mounted to head 50 such that teeth 60 of blade 55 are substantially parallel to teeth 60 of blade 57 forming a cutting edge 61. Motor 30 is operative coupled to reciprocating blade 57 to reciprocate blade 57 back and forth perpendicular to the longitudinal axis of handle 20. Thus, hair placed within teeth 60 is trimmed as blade 57 reciprocates with respect to blade 55.

Referring to FIG. 4, clipper head 50, similar to prior art nose and ear hair clippers, preferably has a cutting assembly 90 including, a concentric outer stationary blade 92 with a series of circumferentially spaced notches 94, the side and bottom edges of which preferably provide a plurality of sharp shearing edges 95, and an inner cylindrical hub 96 with one or more blades 98 circumferentially spaced thereon. Preferably, hub 96 engages the end of a rotating, motor driven shaft 35 protruding from clipper head 50. Preferably, shaft 35 rotates about a central axis B.

Head 50, preferably, is mounted to handle 20 so as to permit the head to pivot about an axis or rotation A. Axis of rotation A is preferably perpendicular to the longitudinal axis of handle 20. Preferably, axis A is offset from cutting assembly 90 in the direction of handle 20. Head 50 is preferably mounted to handle 20 so as to permit motor 30 to reciprocate hub 96, via shaft 35, as the head pivots about axis of rotation A. Thus, clipper 10 enables the user to easily position cutting assembly 90 parallel to the cutting surface.

Referring to FIGS. 3 and 4, handle 20 defines a pair of support arms 40 that preferably form a fork. Each arm 40 preferably has a connector 42 positioned along the axis of rotation A. Head 50 preferably has a pivot point 59 positioned on opposite sides of the head also positioned along the axis of rotation A. Connectors 42 preferably are adapted to secure pivotally pivot points 59 of head 50 to handle 20. Thus, connectors 42 and pivot points 59 are adapted to enable clipper head 50 to pivot about axis of rotation A.

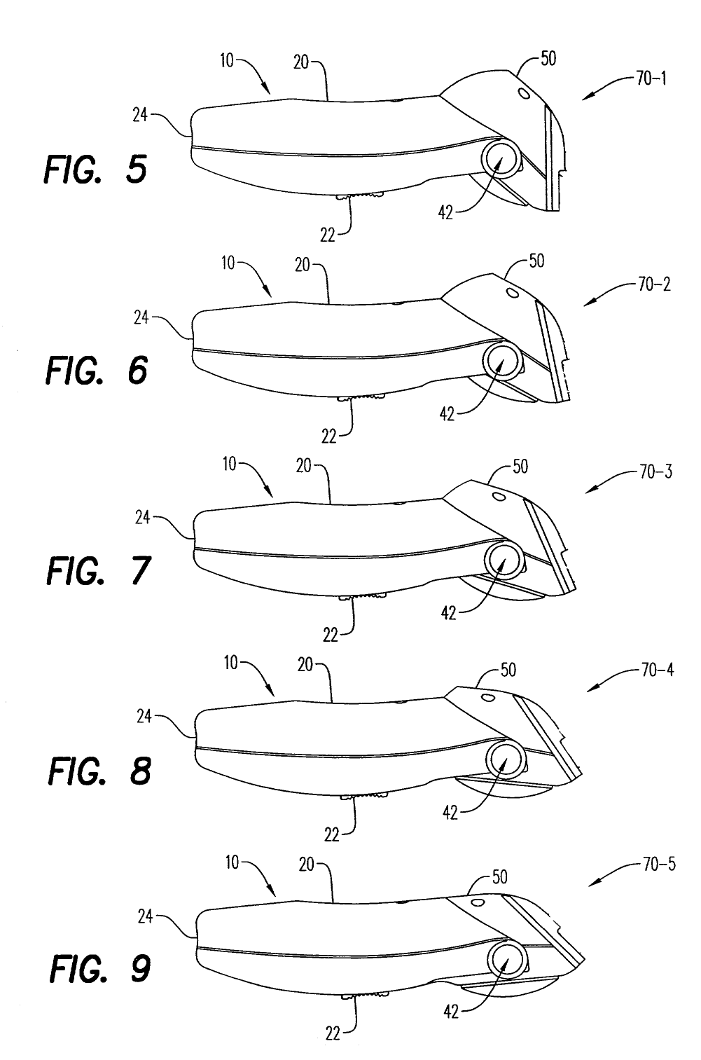

As shown in FIGS. 5 through 9, connectors 42 and pivot points 59 are adapted to secure head 50 within handle 20 in one of several preset pivoted positions 70-1, 70-2, 70-3, 70-4 and 70-5, respectively. Each connector 42 preferably has a first gear 44 and a release button 46 and each pivot point 59 preferably has a second gear 64. First gears 44 are preferably connected to arms 40 so as to mesh with second gears 64 connected to head 50. Release buttons 46 are preferably adapted to extend first gears 44 into meshing relationship with second gears 64 and are adapted to retract the first gears from the meshing relationship with the second gears. Release buttons 46 preferably are adapted to normally mesh first gears 44 with second gears 64, thus securing head 50 in one of the preset plurality of pivoted positions. Depressing release buttons 46 unmeshes first gears 44 from second gears 64. With release buttons 46 depressed and first gears 44 unmeshed from second gears 64, head 50 is pivotable about axis of rotation A to another one of the preset pivoted positions.

It should be understood that the foregoing description is only illustrative of the present invention. Various alternatives and modifications can be devised by those skilled in the art without departing from the invention. Accordingly, the present invention is intended to embrace all such alternatives, modifications and variances that fall within the scope of the appended claims.

What is claimed is

1. An improved hair clipper comprising:
a clipper head including a stationary blade having teeth and a reciprocating blade having teeth, wherein the teeth of the stationary blade are substantially parallel to the teeth of the reciprocating blade forming a cutting edge;
a handle having a longitudinal axis and means for reciprocating the reciprocating blade such that hair positioned within the teeth of the stationary blade are cut by the teeth of the reciprocating blade; and
means for connecting the clipper head and the handle such that the clipper head pivots about an axis of rotation that is perpendicular to the longitudinal axis of the handle and parallel to the cutting edge.

2. The hair clipper of claim 1, wherein the connecting means comprises:
at least one leg disposed on the handle and offset from the longitudinal axis of the handle;
a first connector disposed on the at least one leg; and
a second connector positioned on the clipper head,
wherein the first and second connectors join the clipper head to the leg of the handle such that the clipper head pivots about the axis of rotation.

3. The hair clipper of claim 1, wherein the connecting means is adapted to join the clipper head and the handle such that the clipper head is securable in any one of a plurality of preset pivoted positions.

4. The hair clipper of claim 3, wherein the connecting means comprises:
at least one leg disposed on the handle and offset from the longitudinal axis of the handle;
a first connector disposed on the at least one leg; and
a second connector positioned on the clipper head,
wherein the first and second connectors join the clipper head to the leg of the handle such that the clipper head pivots about the axis of rotation and such that the clipper head is securable in any one of the plurality of pivoted positions.

5. The hair clipper of claim 4, wherein the first connector is a first gear, the second connector is a second gear, and the connecting means includes means for meshing and unmeshing the first gear and the second gear, such that when the first gear is meshed with the second gear the clipper head is secured in any one of the plurality of pivoted positions, and when the first gear is unmeshed from the second gear the clipper head is pivotable about the axis of rotation.

6. The hair clipper of claim 5, wherein the means for meshing and unmeshing comprises a release button adapted to mesh the first gear with the second gear and adapted to be depressed to unmesh the first gear from the second gear.

7. The hair clipper of claim 1, wherein the reciprocating means comprises a motor.

8. The hair clipper of claim 7, wherein the handle further comprises:
a switch having an on position and an off position, and
a cord with a plug,
wherein the motor is operatively coupled to the cord when the switch is in the on position such that power flows to the motor from a standard household electrical outlet that receives the plug.

9. The hair clipper of claim 7, further comprising a rechargeable battery operatively coupled to the motor.

10. The hair clipper of claim 9, wherein the handle further comprises:
a switch having an on position and an off position, and
a plug,
wherein the motor is operatively coupled to the battery when the switch is in the on position such that power flows from the battery to the motor.

11. The hair clipper of claim 10, wherein the handle further comprises:
a recharging indicator and wherein the battery is operatively coupled to the plug and the recharging indicator such that when the switch is in the off position power flows from a standard household electrical outlet that receives the plug to deliver power to recharge the battery and to operate the recharging indicator.

12. The hair clipper of claim 11, wherein the recharging indicator has a first state indicative of the battery recharging and a second state indicative of the battery fully recharged.

13. The hair clipper of claim 1q1, wherein the recharging indicator comprises an LED, said LED is illuminated when the battery is recharging and is not illuminated when the battery is fully recharged.

14. A hair clipper comprising:
a clipper head including pivot points positioned on opposite sides of the head, a stationary blade having teeth and a reciprocating blade having teeth, wherein the teeth of the stationary blade are substantially parallel to the teeth of the reciprocating blade forming a cutting edge; and
a handle having a longitudinal axis, a pair of legs, a connector disposed on each leg, and means for reciprocating the reciprocating blade such that hair positioned within the teeth of the stationary blade are cut by the teeth of the reciprocating blade,
wherein each connector is adapted to engage one of the pivot points such that the clipper head is pivotable about an axis of rotation perpendicular to the longitudinal axis of the handle and parallel to the cutting edge.

15. The hair clipper of claim 14, wherein the connectors and the pivot points are adapted to join the clipper head and the handle such that the clipper head is securable in any one of a plurality of preset pivoted positions.

16. The hair clipper of claim 15, further comprising a means for selectively releasing and securing the connectors and the pivot points such that when the connectors and pivot points are secured the clipper head is secured in any one of the plurality of pivoted positions, and when the connectors and pivot points are released the clipper head is pivotable about the axis of rotation.

17. The hair clipper of claim 16, wherein the connectors are first gears, the pivot points are second gears, and the releasing and securing means is adapted to release and secure the first gears with the second gears, respectively, such that when the first gears are secured with the second gears the clipper head is secured in any one of the plurality of pivoted positions, and when the first gears are released from the second gears the clipper head is pivotable about the axis of rotation.

18. The hair clipper of claim 16, wherein the releasing and securing means comprises a release button adapted to normally secure the connectors and the pivot points, and adapted to be depressed to release the connectors and the pivot points.

19. An electric hair clipper comprising:
a clipper head including a stationary blade having teeth and a reciprocating blade having teeth, wherein the teeth of the stationary blade are substantially parallel to the teeth of the reciprocating blade forming a cutting edge;
a handle having a longitudinal axis, a motor for reciprocating the reciprocating blade such that hair positioned within cutting edge are cut; and
means for joining disposed on the clipper head and the handle for joining the clipper head to the handle such that the clipper head pivots about an axis of rotation that is perpendicular to the longitudinal axis of the handle, parallel to the cutting edge and offset from the cutting edge towards the handle.

20. The electric hair clipper of claim 19, wherein the means for joining is further adapted to join the clipper head and the handle such that the clipper head is securable in any one of a plurality of preset pivoted positions.
